(19) United States
(12) Patent Application Publication
(10) Pub. No.: US 2017/0234543 A1
(43) Pub. Date: Aug. 17, 2017

(54) High G-field Combustion

(71) Applicants: Jean-Sébastien Plante, Sherbrooke (CA); Mathieu Picard, Sherbrooke (CA); Alexandre Landry-Blais, Cantons de Hatley (CA); Hugo Fortier-Topping, Sherbrooke (CA); Michael Gurin, Glenview, IL (US); Céderick Landry, Sherbrooke (CA); Patrick Dubois, Sherbrooke (CA); Luc Frechette, Sherbrooke (CA); Benoit Picard, Sherbrooke (CA)

(72) Inventors: Jean-Sébastien Plante, Sherbrooke (CA); Mathieu Picard, Sherbrooke (CA); Alexandre Landry-Blais, Cantons de Hatley (CA); Hugo Fortier-Topping, Sherbrooke (CA); Michael Gurin, Glenview, IL (US); Céderick Landry, Sherbrooke (CA); Patrick Dubois, Sherbrooke (CA); Luc Frechette, Sherbrooke (CA); Benoit Picard, Sherbrooke (CA)

(73) Assignee: Ceragy Engines Inc., Glenview, IL (US)

(21) Appl. No.: 15/164,642

(22) Filed: May 25, 2016

Related U.S. Application Data
(60) Provisional application No. 62/166,124, filed on May 25, 2015.

(51) Int. Cl. F23R 3/56; F02C 3/04; F23R 3/28; F02C 7/264; F23R 3/58; F23R 3/20

(52) U.S. Cl. CPC F23R 3/56; F23R 3/58; F23R 3/20; F23R 3/28; F02C 7/264; F02C 3/04

(57) ABSTRACT

The present invention generally relates to high g-field combustion methods and integrated processes requiring high-energy efficiency and low NOx emissions to maximize fuel productivity and integrated process production output. In one embodiment, the present invention relates to the combustor having a g-field greater than 100,000 g's in an isothermal configuration by achieving concurrent combustion and expansion with the high g-field combustor in a rim-rotor turbomachine.

### CROSS-REFERENCE TO RELATED APPLICATIONS

This patent application claims priority from U.S. Provisional Patent Application No. 62/166,124 also titled “High G-field Combustion” on May 25, 2015.

### FIELD OF THE INVENTION

The present disclosure relates to a combustor and rim-rotor turbomachinery where the combustion process predominantly takes place at high g-field forces and the turbine is radially supported by a composite, including carbon, reinforced rim-rotor that empowers the use of ceramics. Both technologies enable the increase of temperature including in a recuperated Brayton cycle to achieve high efficiency while maintaining low NOx levels.

### BACKGROUND OF THE INVENTION

Due to a variety of factors including global warming issues, fossil fuel availability and environmental impacts, crude oil price and availability issues, alternative combustors with or without power generation methods must be developed to reduce carbon dioxide (CO2) and nitrogen oxides (NOx) emissions.

When considering power generation cycles such as the recuperated Brayton cycle, it is recognized in the art that increasing cycle efficiency requires increasing combustion temperature, yet it is also known that increasing combustion temperature is accompanied by an increasing challenge of maintaining NOx emissions below environmental requirements. Typical gas turbines use lean premixed combustion to minimize the maximum flame temperature within the combustor and hence reduce NOx emissions. However, for recuperated cycles these combustors are limited to air preheat temperatures below the autoignition temperature of the fuel-air mixture to avoid instabilities which can ultimately lead to catastrophic failure of the combustor. Lean premixed combustors are thus restricted to lower recuperated cycle temperatures, and hence lower cycle efficiencies and higher carbon dioxide emissions.

When considering mobile applications, compactness is critical to minimize weight and volume of the engine.

Furthermore, another challenge with increasing the temperature of a recuperated Brayton cycle lies in the turbine itself, where typical alloys require large amounts of cooling to be able to withstand high gas temperatures. This is even more challenging for small scale turbines (<1 MW) where film cooling is very hard to implement and significantly reduces cycle efficiency. Attempts have been made to use ceramics, such as Silicon Nitride and Silicon Carbide, for gas turbines since these materials can withstand very high temperature, but due to their brittleness they show reliability issues. Prior attempts have been made to build ceramic turbines contained in a rim-rotor, such as U.S. Pat. No. 4,017,209, but do not propose a viable cooling solution for the composite rim-rotor, which is limited by glass transition for carbon-polymer composites, or oxidation for carbon-carbon composites. In this specific case, cooling air goes through long slender blades operating beyond 1200 C, meaning the air is inevitably pre-heated, and thus, unless massive mass flows are used, cannot perform any meaningful cooling to a composite rim-rotor having a maximum operating temperature in the 250-350C range, making the approach useless for high-efficiency applications. These attempts have also been limited to purely axial turbine designs, which do not take full advantage of the rim-rotor that could be used for hub-less designs allowing inversed radial, axial or mixed flow configurations that optimize the temperature distribution of the engine packaging by keeping the hot gases on one single side of the turbine wheel, therefore separating structural and thermal loops.

Furthermore, when considering rim-rotor machinery, there is a significant challenge in matching the large displacement of the rim-rotor to the small displacement of a rigid hub. The rim-rotor also needs to be thermally insulated from the hot combustion gases, with ceramics being a choice candidate due to their low conductivity and high temperature resistance. Prior art exists showing attempts to design and build flexible, compliant hubs for rim-rotor machinery as well as thermal protection layers for the rim-rotor. Some of this prior art has been limited to conceptual designs with no experimental validation (GE, Stoffer 1979), or component failure during experimental validation (R. Kochendorfer 1980). These designs failed due to tensile loading of ceramics components under circumferential stress, and hence an improper use of the rim-rotor design to reduce, or even eliminate, the tensile stresses.

Accordingly, there is a need for a compact, low NOx combustor that can operate at high air preheat temperatures without the risk of instabilities or failures, that could be used in industrial (furnaces, heaters) and power applications such as distributed CHP, aerospace and automotive applications. For maximum efficiency and emissions benefits in power applications, this combustor would need to be used with rim-rotor ceramic turbomachinery allowing high combustion temperatures, and hence high cycle efficiency.

### SUMMARY OF THE INVENTION

In a first aspect, the present disclosure provides a high g-field combustor whose embodiment can be in a static, rotating or otherwise accelerating reference frame. The combustor comprises fuel injection sites, flame-holding (or flame-stabilizing) devices, means of igniting the fuel-air mixture and means of generating a high g-field.

In a second aspect, the present disclosure provides a gas turbine configuration that uses a rim-rotor configuration to allow the use of ceramics under compression. The rim-rotor turbine comprises a high-strength composite rim-rotor, ceramic or high temperature alloy counter-flux insulating layer, ceramic or high temperature alloy aerodynamic blades, and a radially flexible hub.

### BRIEF DESCRIPTION OF THE DRAWINGS

FIG. 1 is a schematic view illustrating the principal of operation of a high g-field combustor

FIG. 2 is a cutaway view of an embodiment of a rotating high g-field combustor using a rim-rotor to support the various flame-holders required.

FIG. 3 is a schematic view illustrating the various fuel injection points possible within a high g-field combustor either in a static or rotating configuration.

FIG. 4 is a schematic view illustrating how combustion can be fully completed within the high g-field combustor or only partially within the high g-field combustor and the remainder of the combustion reaction fully completed in a pressure expansion device to achieve isothermal expansion.

FIG. 5 is a schematic view of a static high g-field combustor.

FIG. 6 is a schematic view of a possible embodiment of a high g-field combustor used for a gas turbine application in which the curvature radius of the high g-field combustor can be different than the radius of the turbine, allowing optimum configuration of flow velocity and g-field.

FIG. 7 is a schematic cut view of a high g-field combustor used with a turbine.

FIG. 8 is a CFD result showing NOx concentration contours in ppm in a channel submitted to a large g-field of 100,000 g's in which fuel is injected from the top into a hot air at 1000 K stream and combustion fully takes place within the channel.

FIG. 9 is a CFD result showing Temperature contours in degrees K in a channel submitted to a large g-field of 100,000 g's in which fuel is injected from the top into a hot air at 1000 K stream and combustion fully takes place within the channel.

FIG. 10 is a CFD result showing NOx concentration contours in ppm in a channel submitted to a small g-field of 10,000 g's in which fuel is injected from the top into a hot air at 1000 K stream and combustion only partially takes place within the channel.

FIG. 11 is a CFD result showing Temperature contours in degrees K in a channel submitted to a small g-field of 10,000 g's in which fuel is injected from the top into a hot air at 1000 K stream and combustion only partially takes place within the channel.

FIG. 12 is an embodiment of a high g-combustor used for high radiant applications.

FIG. 13 is a schematic view of a rotating high g-field combustor in which stator guide vanes can be individually closed to control the mass flow rate to the rotating combustor.

FIG. 14 is a schematic view of a rotating high g-field combustor in which stator guide vanes can be individually oriented to control tangential velocity of the flow to the rotating combustor.

FIG. 15 is an embodiment of combining a static high g-field combustor with a ceramic rim-rotor turbomachine.

FIG. 16 is an embodiment of a rim-rotor turbomachine using a rim-rotor, counter-flux insulation substrate, ceramic blades and a compliant hub.

FIG. 17 is a schematic view of a counter-flux insulation substrate consisting of different cooling channel configuration.

FIG. 18 is an embodiment of different counter-flux insulation substrates which can be manufactured using additive manufacturing methods.

FIG. 19 is a schematic view of various rim-rotor turbomachine configurations that isolate the hot combustion gas from critical turbomachine components (shaft, bearings), essentially allowing “hubless” turbines.

### DETAILED DESCRIPTION OF THE INVENTION

Traditional flame propagation mechanism in combustion reactions is driven by turbulent mixing, buoyancy forces between reactants and products, and species diffusion. Under normal low g-field conditions, the buoyancy forces are very small and do not significantly contribute to the flame propagation. However, at high g-fields (at a minimal embodiment of g-field greater than 10,000 g's in which buoyant forces obtain meaningful mixing, and at the preferred embodiment of g-field greater than 100,000 g's in which buoyant forces are dominant), buoyancy forces between combustion products and reactants (or fuel and air) dominate the flame propagation mechanism by greatly increasing the Rayleigh-Taylor instabilities between the fluids, improving mixing between products and reactants and hence increasing the heat release rates. High g-field is the key element for fast mixing and thus short reaction distances and residence times. Furthermore, it is expected that a high g-field rotating combustor would be most beneficial for small scale turbomachinery (<1 MW) because for a given turbine tip speed the g-field is inversely proportional to the machine radius. This results in g-fields in the 100,000 g's for turbines in the 10cm scale, and in over 1,000,000 g's for turbines in the 10 mm scale.

Conventional turbines normally use internally supported blades, i.e. blades that are supported at their root connected to a hub whose diameter is smaller than the root radius of the blade. Such configurations result in the blades being loaded under tensile stress due to the centrifugal forces occurring during rotation, which limits the blades to being made of materials having high tensile strength. These materials are typically metallic alloys that are limited to relatively low temperatures. High temperature materials such as ceramics cannot be used in conventional turbines due to their low tensile strength and high brittleness: any small crack present in the blade will rapidly grow and lead to failure of the turbine due to the tensile loading of the blades. To increase the efficiency of a recuperated Brayton cycle, it is desirable to increase the turbine inlet temperature to levels significantly higher than the maximum allowable blade temperature for metallic alloys. Conventional turbines can achieve this by using blade cooling strategies, but the manufacturing difficulties and efficiency penalties limits it's use to large-scale turbines (>1 MW). For small scale turbines, the only viable approach to increase the turbine inlet temperature is to use ceramic blades, which is only possible using a rim-rotor turbine by holding the blades on their outer radius, the blades are loaded in compression which inhibits crack growth in ceramics. A rim-rotor turbine thus greatly increases the reliability of ceramic blades, which allows an increase in turbine inlet temperatures without the added complexity and cost of blade cooling.

Example embodiments will now be described more fully with reference to the accompanying figures.

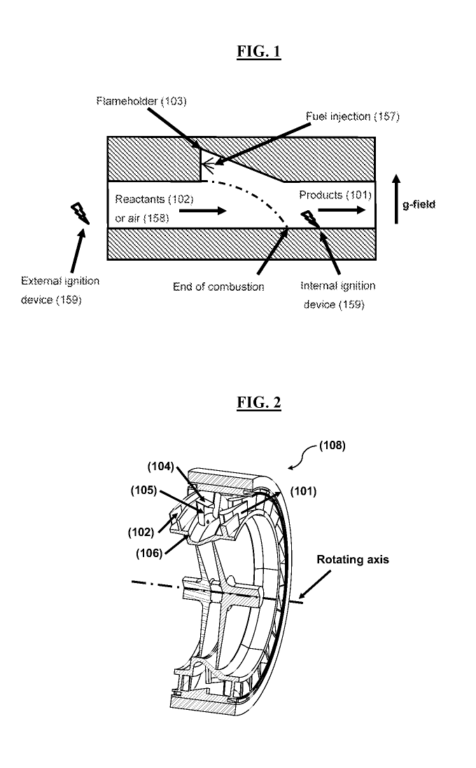

FIG. 1 depicts a high g-field combustor where the combustion reaction is driven by buoyant forces caused by a centrifugal acceleration field and the density difference between combustion products 101 and premixed reactants 102. The g-field can also be used for the mixing of air 158 and fuel 157 to achieve a homogeneous reactants mixture 102 before ignition: fuels heavier than air could be injected on the inner radii and lighter fuels on the outer radii to provoke mixing. High g-field is the key element for fast mixing, short reaction distances and short residence time. In the various contexts of use of a combustor, both cold and highly pre-heated air inlet situations exist. For cold air inlet (below fuel auto-ignition temperature), both non-premixed and premixed combustion need a flame holding device 103 and an ignition device that can be within the g-filed 159 or external to the g-field 195. Prior art (US 2014/0290259 A1) has shown that ignition devices such as glow plugs, spark plugs, sparkles or pilot flames can be used. For hot air inlet (above fuel auto-ignition temperature), only non-premixed combustion is possible and has no need for a flame holding device 103 nor an internal ignition device 159 within the combustor. A flame holding device 103 and internal ignition device 159 may optionally be used for start-up modes until the temperature exceeds the fuel auto-ignition temperature when using a heat-exchanger to pre-heat the combustion air from the exhaust gases.

FIG. 2 is an embodiment of a high g-field combustor in a rotating configuration 108. The g-field is imposed by rotating the combustor around an axis, driving the heavier reactants 102 or air 158 outwards of the rotating axis and the hot combustion products 101 or fuel 157 inwards of the rotating axis. Multiple flame-holding devices such as an upper flame-holder 104, a vertical flame-holder 105 and a lower flame-holder 106 in reference to the g-field direction can be used to stabilize the flame within the combustor. The rotating combustor 108 can be operable with either premixed cold air inlet, non-premixed cold air inlet or non-premixed hot air inlet, with the fuel injection for non-premixed configuration occurring either just before or within the rotating frame.

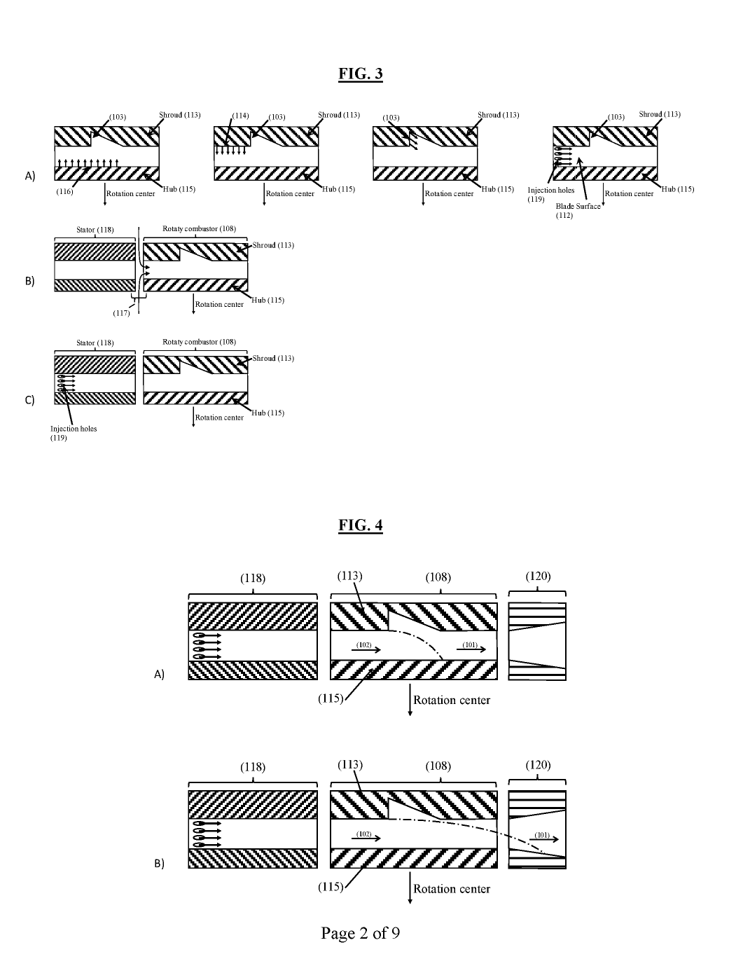

The location of the chemical reaction within the combustor can be shaped by carefully placing multiple injection points in each flow channel of the main combustor. FIG. 3 shows the multiple location scenarios including: A) injection points within the rotating combustor (e.g. from the blades surface 112, from the shroud 113 inner surface 114, from the flame-holders 103 or from the hub 115 outer surface 116, with fuel being transferred to the rotating frame either from the hub or the shroud), B) injection points within the interface or gap 117 between the static inlet and rotating combustor, or C) injection points within the static inlet 118 or ahead of the static inlet from holes 119 in the channel walls. The inventive high g-field rim-rotor is the only configuration that enables injecting fuel from the shroud side, which is good for high g-field combustion since the combustion products 101 will naturally flow across the main flow. Preferably, most of the combustion is done in the rotating frame 108 to limit Rayleigh pressure losses associated with high speed flows.

FIG. 4 shows two embodiments that can be used to design a rotating combustor 108: A) combustion can take place only in the combustor 108 at a constant pressure or B) combustion can be initiated and stabilized in the combustor 108 and can “continuously” take place during a pressure expansion in an expansion device such as a turbine 120 in which work is extracted by means of shaft power. It is understood that “continuous” combustion is when at least 1% of the combustion occurs concurrently with expansion, though preferably continuous combustion is at least 15% of the combustion occurs concurrently with expansion, particularly preferred is continuous combustion is at least 50% occurs concurrently with expansion, specifically preferred is continuous combustion is at least 90% occurs concurrently with expansion. And the absolute best configuration is in which 100% of the combustion takes place concurrently with expansion to achieve full/complete isothermal expansion for the highest thermodynamic efficiency of a shaft power device.

FIG. 5 depicts a high g-field combustor in a static 107 configuration. Reactants 102 or air 159 enter the combustion chamber and are submitted to centrifugal acceleration due to the curvature of the combustion chamber. An outward positioned flame-holder 103 located in the curvature, hence in the g-field, is used to stabilize the flame in the case of premixed combustion. For non-premixed combustion, fuel injection 157 is done within the g-field without a flame-holder (or optionally with a flame-holder solely as a pilot flame-holder or for enhanced flame stabilization). The colder, denser reactants 102 are driven towards the outer radius of the channel whereas the hotter, less dense combustion products 101 are driven inwards. The static configuration can be operable with either cold air or premix inlet, or hot air inlet. For cold intake, an internal ignition device 159 such as a spark plug can be used to ignite the mixture. For hot intake, the ignition device 159 may optionally be used during start-up modes.

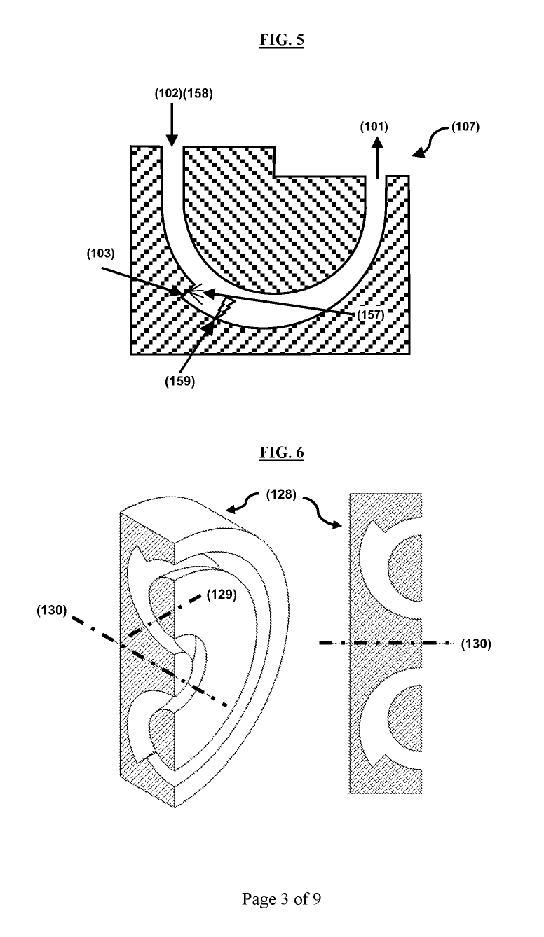

FIG. 6 is an embodiment of a static high g-field combustor 128, where the g-field is created in a non-rotating reference frame by turning the flow around an axis 129 that is perpendicular to the inlet/outlet flow axis 130, is the latter also being the rotation axis of turbomachinery at the combustor outlet. Previous attempts of similar combustors have been limited to swirling type combustors using channels wrapped around the turbine axis of rotation in a way such that the channels and the turbine basically have the same radii and are concentric. This limits the radius of curvature that can be used for the combustor, and results in a sub-optimal combination of velocity, pressure losses, and number of g's. A first order model can be drawn to illustrate this sub-optimal operation. The radius of curvature of a static g-field combustor r_{c}, depends on the flow Mach number M, inlet temperature Tᵢₙ, and desired acceleration a, such that

$${r}_{c} = \frac{{M}^{2} γ {RT}_{in}}{a}$$

where R and γ are gas properties. When designing for ideal design parameters, for example preferred design values of M<0.3 and a>100,000 g's, and a fixed inlet temperature Tᵢₙ, the radius of curvature is found to be unrelated to the turbine radius such as in prior art. Hence prior art designs imply sub-optimal solutions by constraining the radius to be equal to the radius of the turbine. The embodiment shown in FIG. 6 allows the use of different flow radius for the high g-combustor and the turbine. The preferred ratio of turbine radius to combustor radius is greater than 2, the particularly preferred ratio of turbine radius to combustor radius is greater than 5, and the specifically preferred ratio is greater than 10. The larger power rating of the turbomachinery yields a higher turbine radius to combustor radius ratio.

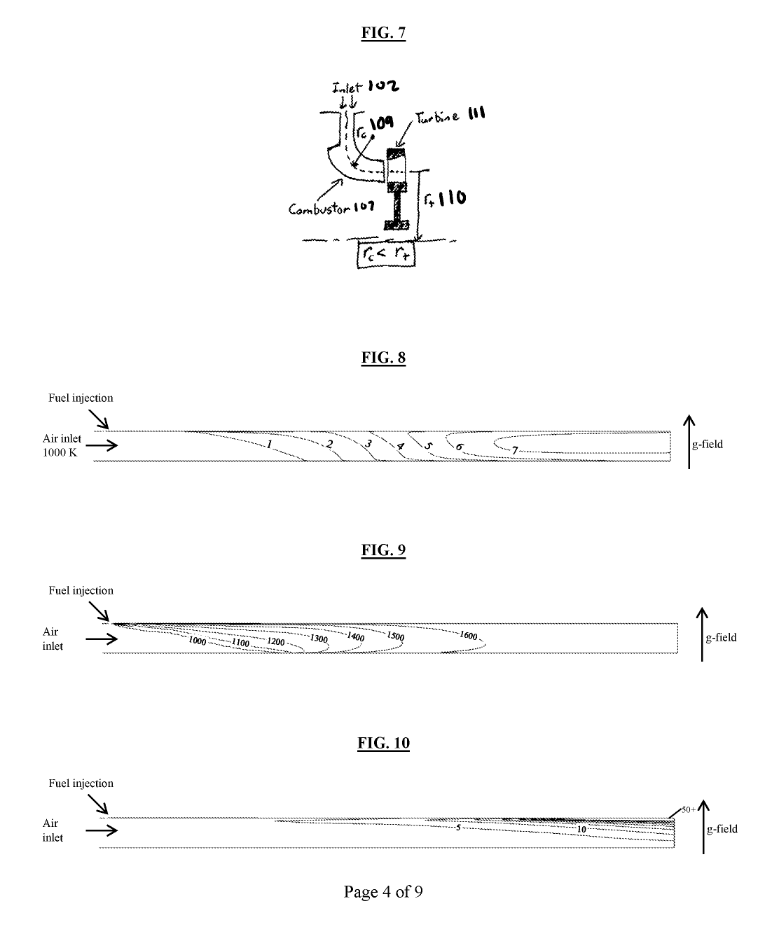

FIG. 7 shows a cutaway of a preferred embodiment of a static g-field combustor 107. To generate high g-fields in static combustors, preference is to have a small radius rather than increasing the velocity to limit Fanno and Rayleigh losses. Preference is for the radius of combustion chamber 109 to always be equal or smaller than the radius 110 of the turbine 111 preferably by at least 10%.

FIG. 8 and FIG. 9 show the results of CFD analysis of methane non-premixed combustion at a g-field of 100,000 g's. NOx concentration in ppm is shown in FIG. 8 and temperature contour in degrees Kelvin is shown in FIG. 9. In the simulations, the g-field is imposed on the reference frame as gravity and fuel injection is done in hot air at 1000 K to achieve non-premixed combustion at overall lean conditions. The results show that very low NOx concentration below 10 ppm is achieved even for combustion temperatures above 1600 K due to very good mixing resulting in low residence time at near-stoichiometric conditions.

FIG. 10 and FIG. 11 show the CFD analysis under the same conditions but at a lower g-field of 10,000 g's. The results show that the temperature is higher than 2000 K, resulting in high NOx concentration above 50 ppm, which is due to poor mixing and long reaction lengths at lower g-fields resulting in higher residence time at near-stoichiometric conditions. High g-field clearly enables a reduction in NOx concentration as well as combustor compactness by at least 50%. The preferred embodiment of the invention has g-fields of at least 100,000 g's in order to have a short combustion distance and corresponding low NOx emissions. The preferred embodiment further maintains a flow Mach number below 0.3 in order to limit Fanno and Rayleigh losses.

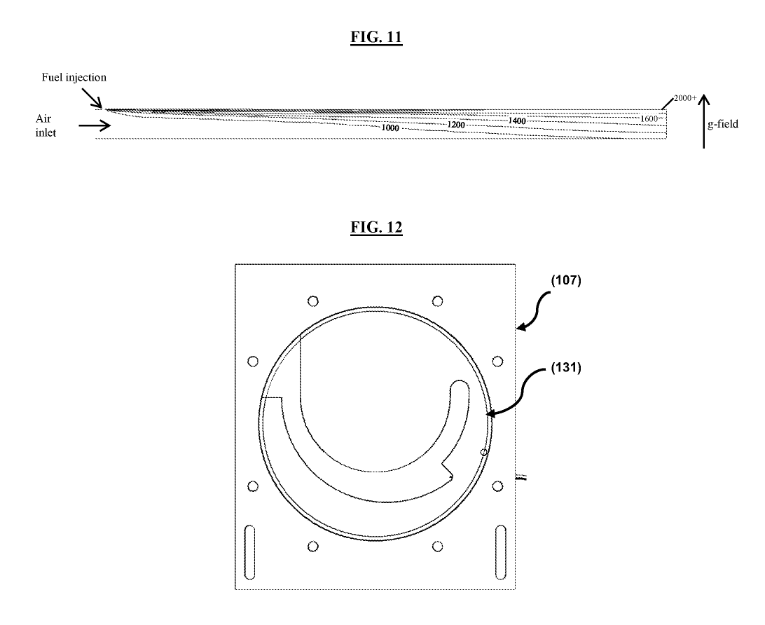

A high radiant combustion process would emit combustion energy in the form of emitted radiation outside of the combustion chamber. High emissivity is preferred (preferably with emissivity greater than 30%, particularly preferred with emissivity greater than 70%, and specifically preferred with emissivity greater than 85%) when the high g-field combustor is utilized for industrial applications including: top cycle or bottom cycle for high radiant processes or industrial processes that can achieve higher production throughput by high radiant heat transfer (e.g., steel, glass, cement, etc.) or higher efficiency in the combination of solid-state energy conversion (e.g., thermophotovoltaic, thermoelectric, photovoltaic, etc.). A standalone high radiant and high g-field combustor with solid-state energy conversion significantly increases emitted energy while uniquely limiting the production of NOx formation. It is understood that the radiated/emitted energy is enabled by using designs with radiation transparent materials and/or by providing an obstacle free path. Such a design is shown in FIG. 12 where a static high g-field combustor 107 has a radiation transparent container 131 that allows high radiant combustion.

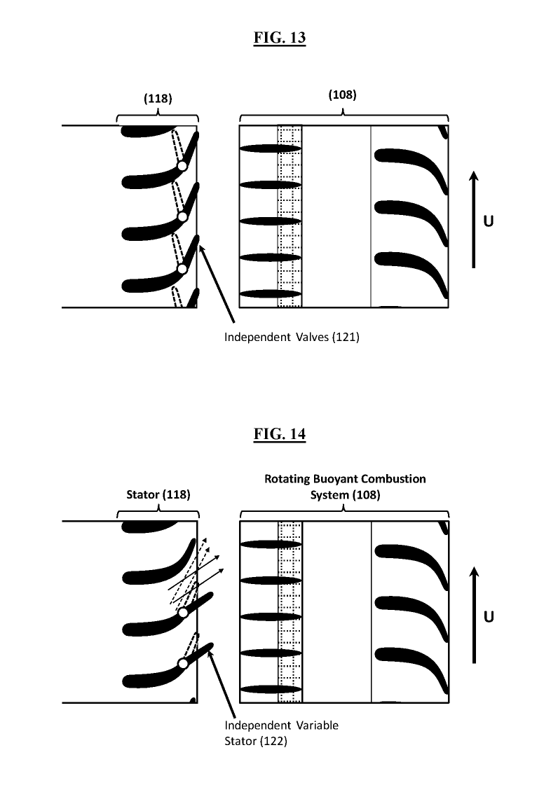

FIG. 13 shows a method of maintaining combustor performance, both static 107 and rotating 108, during load and/or rpm variations by blocking the number of stator 118 channels, with the objective being to keep pre-heated air temperature above fuel ignition temperature under all load condition when using a hot air combustor. Flow can be blocked with a slide valve or a butterfly valve 121 for at least one of the combustor channel passage, preferably all channel passages could be turned ON/OFF individually or collectively. An advantage here is that combustor performance can remain independent of load since each individual (or group of) combustor passage(s) can see a relatively constant mass flow rate. This is a key inventive feature of the highly compact high g-field combustor.

FIG. 14 shows variable stator guide vanes 122 that can be used to change the flow's angular momentum at the stator 118 exit. The fuel injection system consists of multiple injection points 119 that can be turned ON/OFF individually or collectively as a subset of the total fuel injection points for flow modulation depending on operating conditions. Preferred injection point locations are: after the compressor and optional recuperator but before the main combustion chamber, one in each combustor channel of the main combustion chamber, and finally, after the turbine but before the recuperator. In all cases, injectors can be placed in curved channels and benefit from the piping's natural curvature (e.g. recuperator) to generate high g-fields. Another key feature of the invention is to place injectors to provide precise control of system ramp-up and ramp-downs for temperature control to mitigate thermal shock resistance issues on critical components (e.g. notably components made with ceramic materials). It is understood that the injectors will include an igniter such as when the autoignition temperature of the fuel is not reached or to alter the temperature profile within the high g-field combustor.

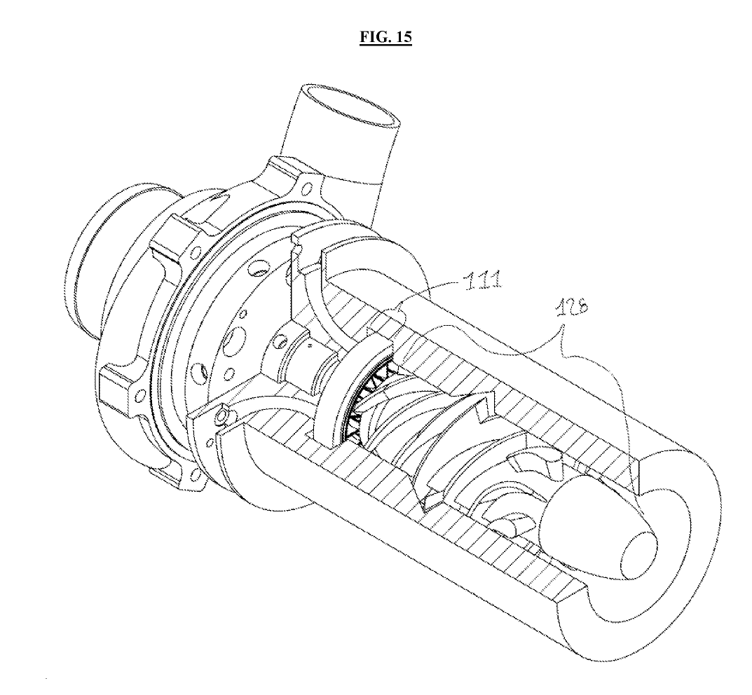

FIG. 15 shows the system combining the high g-field combustor 128 with a ceramic rim-rotor turbomachinery turbine 111, providing a very compact system with high thermodynamic efficiency capability. The short combustion length of the high g-field combustor together with a high temperature rim-rotor turbomachinery turbine consisting of at least one or more composite rings, at least two blades, a counter-flux thermal insulation substrate and whereby the at least two blades are retained under compressive loading, create a very short gas path between pre-combustion and post-expansion, therefore reducing thermal loss by at least 1% when compared to traditional combustor.

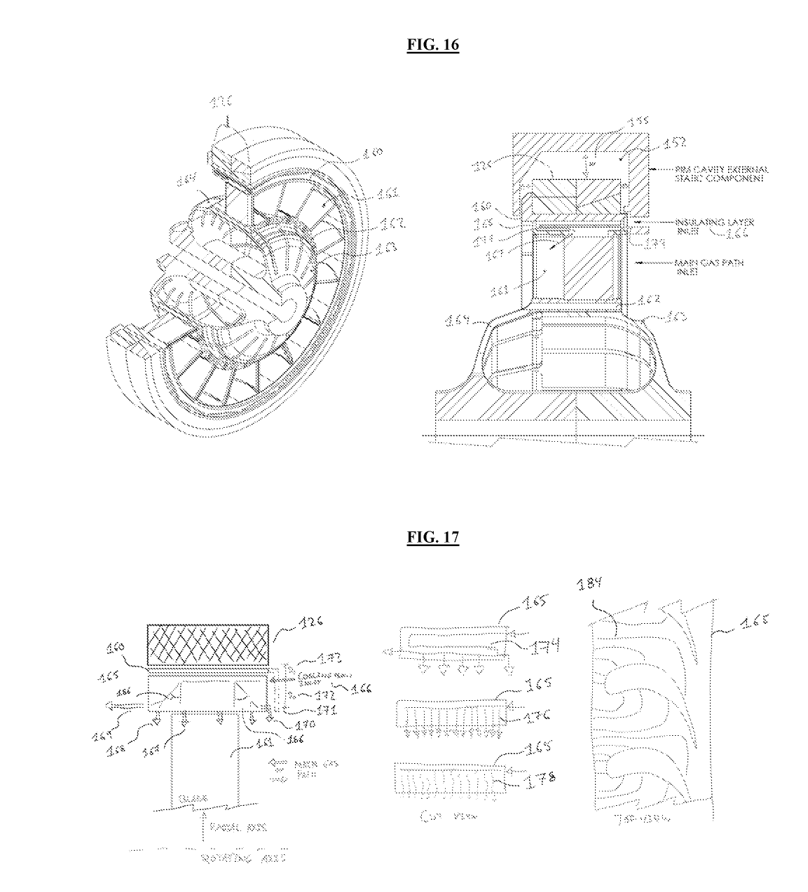

FIG. 16 shows the proposed construction of the rim-rotor turbomachinery turbine 111, which consists of an external rim-rotor 126, supportive shield 160, counter-flux thermal insulation substrate 165 and at least two aerodynamic blades 161, connected to a shaft through opposing arrays of radially compliant springs in the radial-axial plane 163 164. The external rim-rotor 126 can be made from an arrangement of one or more composite rings in the axial and/or radial axis and has the primary function of maintaining the at least two blades under compression loading. The radially compliant hub 163 164 requires at least one array of such compliant springs in order to provide adequate stiffness in all axis in order to be dynamically stable. The at least two blade 161 are in physical communication to the shaft through the at least one rotating array of radially compliant springs comprised of an at least one cantilevered beam in the radial—axial plane, whereby the at least two radially compliant springs are in physical communication with the at least two blades at the first axial position, and to the hub at a second axial position, and whereby the first axial position is different from the second axial position and the second axial position is located at a distance from the shaft greater by at least 0.01 inches from the first axial position. The radial compliance is adjusted by the length of the cantilever beams in the radial-axial plane. The stiffness can be selected by adjusted the thickness and profile of the beams, and if required a second set of beams can be added to largely increase the stiffness of the assembly. If required, the second set of beams can be joined by friction, permanently joined or made in a single piece. In the event where the spring in contact with the blade exceeds its material maximum temperature, cooling eatures that provide cooling flow directly under the blade 162 is the most effective method to maintain the hub structural integrity.

The rim-rotor 126 is insulated by a counter-flux thermal insulation substrate 165, physically located between the rim-rotor and the at least two blades in order to maintain its temperature below its maximum operating temperature. The counter-flux thermal insulation substrate consist of at least two cooling channels, whereby the cooling fluid circulates, having a channel inlet and a channel outlet, whereby the center of the channel inlet 166 is located at a channel inlet distance “D_{I}” 173 from the rim-rotor inner surface to the channel inlet, whereby the channel outlet distance is located at a channel outlet distance “D_{O}+D_{I}” 172 from the rim-rotor inner surface, and whereby the channel inlet distance is at least 0.010 inches greater than the channel outlet distance. The cooling channels further have at least a portion of the channels that have a segment 186 that is at an angle between +45 and −45 from the radial axis. This configuration provides that at least a portion of the cooling flow is being directed radially toward the rotating axis (inward), which is against the dominant temperature gradient, therefore against the dominant conductive heat flux in the channel walls (i.e. counter-flux). Means of producing such radially inward flows are illustrated in FIG. 17. The insulation substrate 165 with at least a portion of the channels that have Z-shape channels 174, U-shape channels 177, micro-channel or micro-holes 176, porous material construction 178, or an arrangement of such. The substrate can be made from metals (e.g. titanium, superalloys), ceramics (e.g. Si3N4, SiC, Mullite, Al2O3, SiO2, ZrO2), blend of ceramics, ceramic coatings or a mix of those options. Superalloys are known in the art as high-performance alloys, being an alloy that exhibits several key characteristics: excellent mechanical strength, resistance to thermal creep deformation, good surface stability and resistance to corrosion or oxidation. In the case where porous material is used, open porosity is required to allow the cooling flow to circulate towards the main gas path. Low porosity, between 50% and 80% by mass, is preferred for material between the rim-rotor and the blade that are subject to compression loading. Higher porosity, between 20 and 50% by mass, is preferred where the insulation substrate is not in contact with the blade in order to reduce the substrate mass. Intricate small sizes required by the substrate optimal features consist of cooling channels of characteristic dimension between 0.004 and 0.040 inches. Preferred micro-holes dimensions are 0.001 to 0.020 inches.

FIG. 18 shows example of design implementing the advantages of additive manufacturing. By removing material at selected section(s), the insulation substrate consisting of a continuous monolithic material ring with intricate radially inwards flow channels 180 provides the low circumferential stiffness required to follow the rim-rotor circumferential expansion without breaking. This configuration is especially adapted to the additive manufacturing (also known as 3d printing manufacturing and used interchangeably throughout), but can also be fabricated using substractive manufacturing methods. This configuration also introduces radial micro-holes at selected position 185. A insulation substrate made of at least one layer of individual bricks 181 with complex cooling channels, which can also be produced with additive manufacturing or other manufacturing method, prevent the counter-flux thermal insulation layer from breaking due to rim-rotor circumferential expansion while undergoing centrifugal loading. In specific configurations, the optimal insulation substrate can be made with the same material as the at least two blades, and therefore the insulation substrate bricks or ring can be joined of directly fabricated together with at least one blade 182 by different method including soldering, casting, machining, additive manufacturing, diffusion bonding or laser welding. In given specific configuration, it is important to introduce a supportive shield 160 between the rim-rotor and the insulation substrate to distribute uniformly the centrifugal forces between substrate features and the rim-rotor, reducing the stress concentration at the contact of surfaces. The supportive shield 160 may provide axial constraints for the insulation substrate by incorporating at least one side will with positive locking features. The supportive shield 160, may also provide an effective mean of integrating different type of seals 179 having therefore a sealing function between the main flow and the cooling flow inlet to avoid hot gas being directed to the cooling channels and to reduce by at least 5% the amount of cooling fluid leaking in a non-cooling channel region (i.e., the main gas path), especially in configuration(s) where the insulating substrate is built from bricks and has tangential breaks or gaps. In addition, the supportive shield 160 is used in given embodiment(s) to provide a tightly controlled axial gap in front of one or more of the exit of the insulation substrate 171, which provides an effective mean of controlling the flow rates of small cooling flows. Gaps between the insulation substrate cooling channel outlet and the supportive shield ranging between 0.002 and 0.020 inches creates a flow area that provides adequate regulation of the cooling fluid flow rate. The supportive shield 160 can consist of one or more part to complete its function.

In order to reduce the amount of cooling flow, which directly impacts the efficiency of the turbomachinery, the counter-flux thermal insulation substrate is preferred to the prior art where only a mix of axial and tangential cooling flow is used. In a configuration where the rim-rotor in wounded from carbon fiber in a polymer matrix, the maximum operating temperature of the insulation substrate 165 is much greater than the maximum operating temperature of the rim-rotor 126, therefore the cooling flow exiting the insulation substrate which has inward radial feature allows the cooling flow to get up to the maximum temperature of the substrate and extract considerably higher amount of heat, having effectively a higher calorific capacity for a given flow rate. The axial and tangential cooling flow of the prior art is in direct or indirect thermal contact with the rim-rotor 126 until the channel exit, which limits the temperature of cooling flow to the maximum temperature of the rim-rotor itself, extracting less heat, and therefore requiring considerably higher amount of cooling flow. Furthermore, the cooling channel air flow is also self-stabilized due to the high-g field where the density difference between hot and cold fluid is such that the coldest fluid is sent toward the cooling channels inlet, and therefore protects the rim-rotor, while the hottest fluid is sent toward the cooling channel exit. The counter-flux insulation substrate would reduce the cooling flow required from approximately 5+% to less than 1% of the main flow, therefore by at least a 20% reduction in cooling flow up to the optimal and specifically preferred cooling flow reduction by at least 80%. Based on approximately 0.5 point of cycle efficiency loss per 1% of main flow used for cooling, the counter-flux insulation substrate results in efficiency gain of 2+ point on the cycle, therefore by at least a 0.5% of cycle efficiency up to the optimal of at least a 2.0% of cycle efficiency in the specifically preferred embodiment.

In addition to the benefit of the increase calorific capacity, the radial inward features allow at least a portion of the cooling flow to be used as transpiration cooling (preferably 50%, up to the optimal of 100% in the specifically preferred embodiment), effectively injecting cold air between the main gas path and the insulation substrate. This creates the film-cooling effect, defined by an insulating layer of cold air between the surface of the insulating substrate and the hot main flow to reduce wall temperatures and thus heat flux. This effect is typically used on turbine blades or static shroud surfaces, which are not radially inward in the rotating frame like in this embodiment. The high centrifugal forces, combined with the density difference between the injected cooling flow that is relatively cold and the main gas flow that is hot, provides a highly beneficial stabilizing effect on the film-cooling layer by generating stratification between the hot and cold gases therefore limiting mixing to a lower level. This lower level of mixing keeps a colder gas temperature near the insulating substrate inner wall, therefore reducing the heat transfer to the insulating substrate and the subsequent radially outward component (i.e. the rim-rotor). The film cooling itself, and the stabilization of the film cooling due to high centrifugal forces, are essential distinctions from rim-rotor prior art to insulate the thermal flux from the primary gas flow to the rim-rotor and provides about 50% of the benefit claimed by the insulating substrate. Furthermore, the inventive transpiration cooling utilizing a cooling flow inlet at a radius closer to the rim-rotor eliminates above 80% of the thermal stress gradient within the turbine blades compared to a configuration where the cooling flow inlet is further away from the rim-rotor, being from the hub and through the blades in the prior art, which is particularly important in ceramic blades that are subject to thermal shock.

Another advantage of this embodiment is the ability to design the cooling channels to direct the cooling flow to the higher heat flux region, which is typically the contact surface between the blade and the insulation substrate 184. It is preferred that the ratio between the cooling flow directed to the channels thermally connected to the contact surface of the blade and the total cooling flow is sized to match the heat flux ratio between the conduction from the blade and the convection under the insulation substrate. The heat flux ratio for this configuration is typically 50%, therefore the recommended cooling flow ratio directed over the blades is between 35 and 65%. All cooling flow can then be directed through the at least one main channel the front (or inlet side) 170, to the back 169 (opposite from the front side), or radially into the main flow through at least two orifices 168. Specific configurations requires that at least 5% of the totality of cooling fluid exits the at least one main channel through the at least two orifices located on the insulation substrate inner wall.

Another embodiment of a rim-rotor turbomachine further comprised of a rim-rotor cavity 152, a rotating boy and a static housing, utilizes fuels or inert gases to protect components from oxidative degradation at high temperature. In particular when oxidation sensitive rim-rotor materials such as carbon-fiber polyimide or carbon-carbon composites are used. The rim-rotor cavity 152 is filled with non-oxidative gases such as inert gases (nitrogen, helium) or non-oxidative fuels (e.g. hydrogen, methane, propane) to limit/prevent oxidation of the material. The fuels or inert gases will also concurrently reduce windage drag of rotating components. In particular, the rim-rotor 126 surfaces are moving at high relative velocities and generate frictional drag with fluids from surrounding environment. Drag is a function of gas density, hence filling the rim-rotor cavity 154 with gases having molecular weight preferably 40% lower than air, and specifically preferably 90% lower than air (e.g., methane, helium, hydrogen) minimizes drag. In order to minimize drag, whether the cavity contains air or other gases, the optimal radial and axial gap(s) 155 that minimizes windage losses is between 0.020 to 0.200 inches. The actual gap is a balance between viscous losses at a small gap and turbulence induced losses at large gaps.

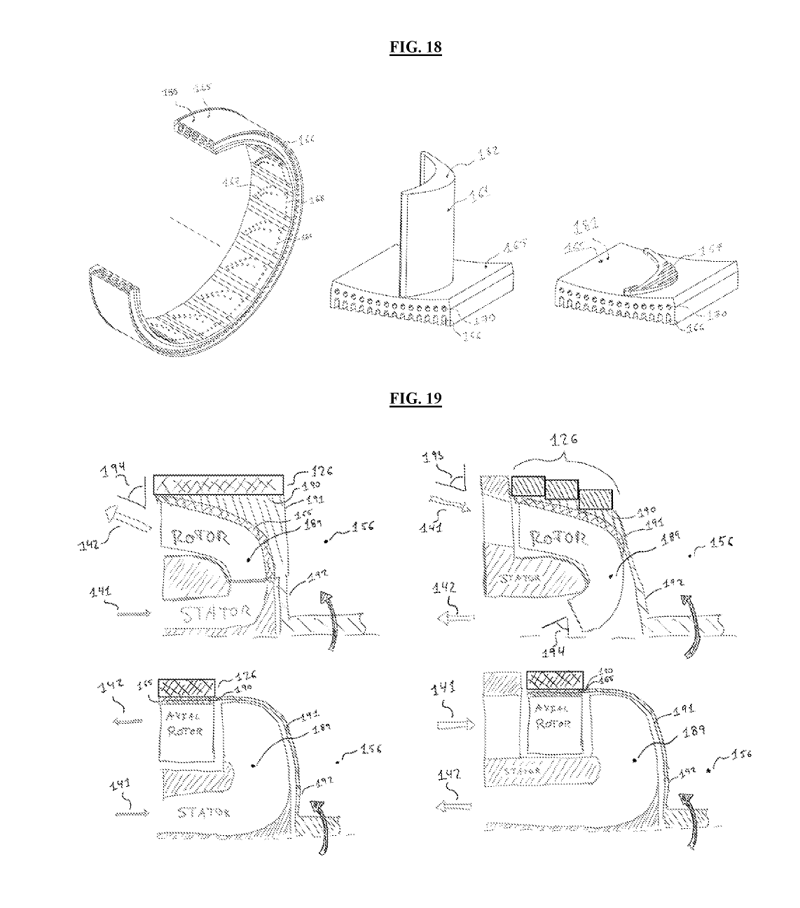

In order to improve the thermal management of the turbomachinery, it is beneficial to isolate the main gas path from the shaft, bearings and other turbomachinery components. FIG. 19 depicts the general configurations that provides the isolated “gas” side 189 from the “shaft” side 156. Those configurations all provide the advantage of not having a structural component in contact with the bottom of the blade (void from the hub or “hubless”), providing easier thermal implementation with ceramic blade (e.g. Si3N4, SiC), especially in configuration where hot combustion exhaust products gases are acting on the at least two baldes in the “gas” side 189, and the advantage of a lighter structure, therefore able to achieve higher tangential speed of the hot gas path meanline in excess of 400 m/s. The connection between the blade and the shaft is made through the rim-rotor 126 or through the counter-flux thermal insulating substrate 165. The main flow inlet 141 can either be located at the inner radius or the outer radius, and the main flow exit 142 is at the opposite. Both pure axial flow, and partially radial flow (also known as mixed flow) configuration are possible. In the mixed flow configuration, the inlet 193 can be at a range of angles between 0 and 90 degrees relative to the radial plane, with a preferred 45 degree to maximize the ratio of inlet radius over exit radius while maintaining structural integrity. The exit 194 can also be at a range of 0 to 90 degrees. The gas side 189 circumscribes the rim-rotor's inner surface 190 and a side face 191 of the connecting element 192.

The high g-field combustor is a key inventive component with the embodiment of a rim-rotor turbomachinery, most notably when the rim-rotor turbomachinery is a ceramic turbomachinery with high tip speed (e.g. compressor, turbine, rotating ramjet, or rotating combustors). Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A high g-field combustor having a combustion reaction subjected to a gravitational field greater than 10,000 g's and whereby said gravitational is generated either by forcing a flow curvature or by forcing a rotation speed of the combustor around a rotation axis, in both cases generating a centrifugal acceleration on the gases undergoing the combustion reaction.

2. The high g-field combustor according to claim 1 whereby the combustion exhaust is a result of a combustion reaction of a fuel source and whereby the combustion reaction of at least 50% of the fuel source occurs within a combustion reaction length and a flow channel height and wherein the combustion reaction length to flow channel height ratio is less than 5.

3. The high g-field combustor according to claim 1 further comprised of an expansion device downstream of the high g-field combustor, wherein the high g-field combustor has a high g-field combustor length and has a combustion reaction whereby the combustion exhaust is a result of a combustion reaction of a fuel source and whereby the combustion reaction of at least 10% of the fuel source occurs within the high g-field combustor length and wherein the combustion reaction is completed within the expansion device operable as an isothermal expansion.

4. The high g-field combustor according to claim 1 further comprised of a fuel injection site, a rotating combustor, a hub, and a shroud and wherein the fuel injection site is located in the rotating combustor on the hub or the shroud.

5. The high g-field combustor according to claim 4 further comprised of a fuel injection site, a rotating combustor, a hub, and a shroud and wherein the combustor has a static inlet, and whereby the fuel injection site is located in the static inlet on the hub side of the combustor.

6. The high g-field combustor according to claim 4 further comprised of a fuel injection site, a rotating combustor, a hub, and a shroud and wherein the combustor has a static inlet, and whereby the fuel injection site is located in the static inlet on the shroud side of the combustor.

7. The high g-field combustor according to claim 4 further comprised of a fuel injection site, a rotating combustor, a hub, a shroud and a flow passage and wherein the fuel injection site is located in the middle of the flow passage.

8. The high g-field combustor according to claim 4 further comprised of an ignition source within the rotating combustor.

9. The high g-field combustor according to claim 4 further comprised of an ignition source within a static inlet of the rotating combustor.

10. The high g-field combustor according to claim 1 further comprised of at least one fuel source, at least one fuel injector, a control system having a at least one temperature sensor to measure temperature in the high g-field combustor or downstream of the high g-field combustor whereby the control system modulates the at least one fuel source flow rate through the at least one fuel injector to maintain a rate of temperature change of the at least one temperature sensor less than a rate change limit threshold specified by the thermal shock limit of downstream components of the high g-field combustor such as a ceramic expansion device or a ceramic heat-exchanger.

11. The high g-field combustor according to claim 1 further comprised of at least one flame-holding device including an upper flame-holder, a vertical flame-holder and a lower flame-holder in relation to g-field direction operable to stabilize the flame within the high g-field combustor.

12. The high g-field combustor according to claim 1 further comprising a rim-rotor, an at least two blades, a counter-flux thermal insulation substrate, whereby the rim rotor contains an at least one or more composite rings whereby the at least one or more composite rings maintain the at least two blades under compressive loading and whereby the counter-flux thermal insulation substrate is physically located between the rim-rotor and the at least two blades.

13. The high g-field combustor according to claim 12 having a thermal loss at least 1% lower than a thermal loss of either a traditional combustor with a rim-rotor in structural communication with the at least two blades or a high g-field combustor without a rim-rotor in structural communication with the at least two blades.

14. The high g-field combustor according to claim 13 wherein the rim-rotor is further comprised of a rim-rotor inner surface, an at least two cooling channels having a channel inlet and a channel outlet, and a cooling fluid whereby the cooling fluid circulates into the at least two cooling channels, whereby the channel inlet is located at a channel inlet distance from the rim-rotor inner surface to the channel inlet, whereby the channel outlet distance is located at a channel outlet distance from the rim-rotor inner surface, and whereby the channel inlet distance is at least 0.010 inches greater than the channel outlet distance.

15. The high g-field combustor according to claim 14 whereby the counter-flux thermal substrate having the at least two cooling channels is comprised of at least one layer of individual bricks operable to prevent the counter-flux thermal insulation layer from breaking due to rim-rotor circumferential expansion while undergoing centrifugal loading.

16. The high g-field combustor according to claim 1 further comprised of a supportive shield having positive locking features including a side wall, whereby the supportive shield is physically between the counter-flux thermal substrate, whereby the rim-rotor provides a uniform radial load distribution and whereby the supportive shield constrains the counter-flux thermal insulation layer in the axial direction.

17. The high g-field combustor according to claim 1 whereby the rim-rotor has at least one main flow channel, whereby the counter-flux thermal insulation substrate has an inner wall, whereby the at least one main flow channel has an at least two orifices, and whereby at least 5% of the totality of a cooling fluid exits into the at least one main flow channel through the at least two orifices of the counter-flux thermal insulation substrate inner wall.

18. The high g-field combustor according to claim 1 further comprised of an at least two cooling channels having a channel inlet and a channel outlet, a cooling fluid whereby the cooling fluid circulates into the at least two cooling channels, a supportive shield whereby the supportive shield is operable as a cooling fluid regulator regulating a cooling fluid flowrate in the at least one cooling channel by sizing a flow area constrained to be between the supportive shield and the counter-flux thermal insulation substrate.

19. The high g-field combustor according to claim 1 further comprised of a shaft, a hub, an at least one rotating array having at least two radially compliant springs, whereby the rim-rotor, the counter-flux thermal insulation substrate, whereby the at least two blades has an at least one first axial position and has an at least one second axial position and the at least two blades are in physical communication to the shaft through the at least one rotating array of radially compliant springs comprised of an at least one cantilevered beam in the radial—axial plane, whereby the at least two radially compliant springs are in physical communication with the at least two blades at the first axial position, and to the hub at a second axial position, and whereby the first axial position is different from the second axial position and the second axial position is located at a distance from the shaft greater by at least 0.01 inches from the first axial position.

20. The high g-field combustor according to claim 17 whereby the high g-field combustor produces a hot combustion exhaust product, whereby the rim-rotor has a main flow acting on the at least two blades and whereby the hot combustion exhaust product is in a second side.
